(19) United States
(12) Patent Application Publication
(10) Pub. No.: US 2014/0188898 A1
(43) Pub. Date: Jul. 3, 2014

(54) APPARATUS AND METHOD FOR FAST DATA SEARCHING

(71) Applicant: Touch Technologies, Inc., San Diego, CA (US)

(72) Inventor: Daniel Esbensen, Blue Diamond, NV (US)

(21) Appl. No.: 14/145,927

(22) Filed: Dec. 31, 2013

Related U.S. Application Data
(60) Provisional application No. 61/747,894, filed on Dec. 31, 2012.

(51) Int. Cl. G06F 17/30

(52) U.S. Cl. CPC G06F 17/3053; G06F 17/30542
USPC 707/748; 707/780

(57) ABSTRACT

Apparatus and method searching data in a multi record data structure with at least first and second criteria where criteria are selected for search to preferentially select criteria for speeding search based on criteria from other records.

### CROSS REFERENCE TO RELATED APPLICATIONS

This application claims priority from provisional patent application 61747894 filed 2012 Dec. 31 and incorporated herein by reference.

### FIELD OF THE INVENTION

The present invention relates to information processing systems and methods. More particularly, the present invention is directed to methods and/or apparatus relating to handling and searching data in databases, particularly digitally stored data, often stored in a tangible media. In particular embodiments, the invention may be understood as involving improved systems for searching data in computer systems.

### COPYRIGHT NOTICE

Pursuant to 37 C.F.R. 1.71(e), Applicants note that a portion of this disclosure contains material that is subject to and for which is claimed copyright protection (such as, but not limited to, source code listings, screen shots, user interfaces, or user instructions, or any other aspects of this submission for which copyright protection is or may be available in any jurisdiction.). The copyright owner has no objection to the facsimile reproduction by anyone of the patent document or patent disclosure, as it appears in the Patent and Trademark Office patent file or records. All other rights are reserved, and all other reproduction, distribution, creation of derivative works based on the contents, public display, and public performance of the application or any part thereof are prohibited by applicable copyright law.

### BACKGROUND OF THE INVENTION

A task that is commonly performed in computer systems is searching for various kinds of data through various databases. Many different search techniques are known, but for many types of searches, optimal techniques have not been determined.

As one example, given a database table with 1000 rows or records or data structures, it may be desired to find the first row or all rows that contains all of three criteria, referred to generally in this example as criteria A, B, and C.

In a traditional search, start with row #1, and see if criteria A is true. If it is not true, advance to row #2 and see if criteria A is true. If it is true, see if criteria B is true. If not, advance to row #3 and see if criteria A is true, etc.—and continue to do this until either the search has finished with row #1000, or a row (or rows) is found where A, B, and C are all true.

### SUMMARY OF THE INVENTION

The present invention in various embodiments entails a method and/or apparatus and/or digital logic circuit for dramatically improving searching of certain databases or data structures. In specific embodiments, the invention can dramatically improve searching times.

The invention and various specific aspects and embodiments will be better understood with reference to the following drawings and detailed descriptions. For purposes of clarity, this discussion refers to devices, methods, and concepts in terms of specific examples. However, the invention and aspects thereof may have applications to a variety of types of devices and systems. It is therefore intended that the invention not be limited except as provided in the attached claims.

Furthermore, it is well known in the art that logic systems and methods such as described herein can include a variety of different components and different functions in a modular fashion. Different embodiments of the invention can include different mixtures of elements and functions and may group various functions as parts of various elements. For purposes of clarity, the invention is described in terms of systems that include many different innovative components and innovative combinations of innovative components and known components. No inference should be taken to limit the invention to combinations containing all of the innovative components listed in any illustrative embodiment in this specification.

The functional aspects of the invention that are implemented on a computer, as will be understood from the teachings herein, may be implemented or accomplished using any appropriate implementation environment or programming language, such as Python, Perl, C#, C++, Cobol, Pascal, Java, Java-script, assembly or machine code programming, custom logic circuits, etc. All references, publications, patents, and patent applications cited herein are hereby incorporated by reference in their entirety for all purposes.

In various embodiments, the invention involves handling data that is presented to a user as an useful output, such as a screen display of an image or text. Such outputting of digital data is understood in the art and examples are provided herein.

### BRIEF DESCRIPTION OF THE DRAWINGS

FIG. 1 is a flow chart illustrating a general search method according to specific embodiments of the invention.

FIG. 2 is a flow chart illustrating an alternate search method according to specific embodiments of the invention.

FIG. 3 illustrates an example architecture of an example information handling system relevant to various specific embodiments of the present invention.

FIG. 4 is a block diagram showing a representative example logic device in which various aspects of the present invention may be embodied.

### DESCRIPTION OF SPECIFIC EMBODIMENTS

### Overview

According to specific embodiments, the invention involves refinements in criteria searching in various types of tables and data structures. Rather than using the compare method described above, according to specific embodiments, the invention uses a cyclical compare of fields or criteria within data structures when looking for structures that meet multiple criteria.

The invention will first be illustrated with a very simple example, involving just three criteria, A, B, and C and indicating a row or record as a data structure:
start with row or record #1, and see if criteria A is true.
If A is not true, advance to record #2 and see if criteria B is true.
If B is not true, advance to record #3, but continue to see if criteria B is true.
If B is not true, advance to record #4, etc.
If B is true in record #2 or #3, check if criteria C is true.
If C is true, and since C is the final criteria, check to see if criteria A is true.
If it is true then the search has found a match.
If either criteria C or criteria A were not true, advance to record #4 and continue to see if criteria C is true.
If C is not true, advance to record #5, and since at the last criteria, see if criteria A is true in record #5.

One advantage of the invention is a speed improvement in most real world data because it is unlikely that all criteria will be distributed equally throughout the table. If, for example, criteria B is rarely true, the invention avoids a high percentage of criteria A compares.

While this simple example illustrates specific embodiments of the invention, more complex searches in different types of data structures can also be enhanced. Furthermore, criteria, e.g., A, B, and C, need not be filled or specified values, but can be equations or functions related to the data structure.

Thus, in another embodiment, the invention can be described as multiple-criteria searching of records or data structures using an information processing apparatus where starting with an initial record, if a first criteria is not true, advance to a next record and see if the second criteria is true and so long as the second criteria is not true, advance to one or more further records and continue to check if the second criteria is true. If the second criteria is true, check the to next criteria in that record, and so long as the next criteria is not true, continue to check the next criteria for following records. When the next criteria is true, continue checking further criteria as above until either all the records are determined to have at least one false criteria or one or more records are determined to have all criteria true. The searching can continue to move through all of the criteria multiple time, but will tend to mostly search the criteria that are most often false. By doing so, many compare operations are avoided.

While the criteria are described in some order, e.g., 1^{st}, 2^{nd}, 3^{rd}, there might not be a natural order to criteria or records, for example in object orientated databases. Thus, the invention can also be described as beginning at any record, examine a criteria, and if that criteria is false, continue to use that criteria to determine records that do not meet at least one criteria. Whenever a criteria is true in a record, examine another criteria in the record and if the another criteria is false continue to use the another criteria to examine subsequent records until the another criteria is true. Again, when a final criteria is true, check to see if the first criteria and any unchecked criteria are true and if all criteria in a record are true, then the search has found a match.

### Further Embodiments

Any number of adjustments or refinements can be made to the basic searching procedure described above and are still in the scope of the invention. For example, according to specific embodiments, the invention can optionally keep a counter for how many times each criteria is false. And then at calculated intervals, the invention reorders the criteria checking—checking the criteria that is the “most false” first, etc.

In further embodiments, the invention might determine or know that some criteria take longer to check than others (or, in other words “cost more” to search)—for example criteria B might requires extra disk I/Os or requires more calculations. In this case, the criteria can be reordered, factoring in both the cost of checking the criteria and “most false”.

### General Methods

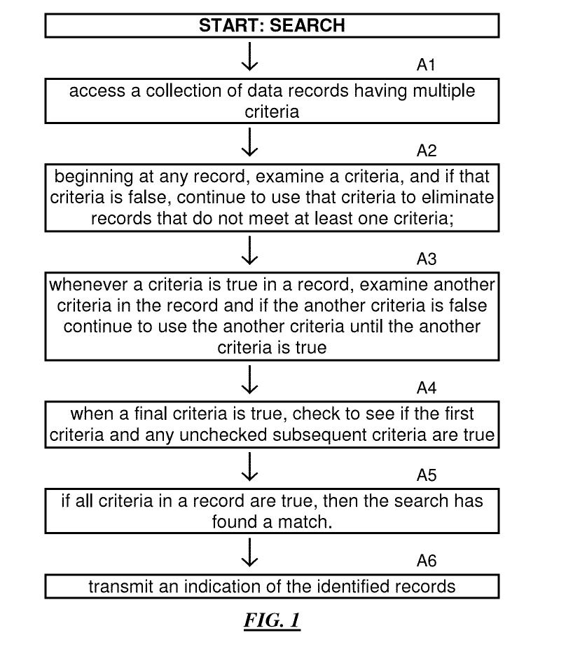

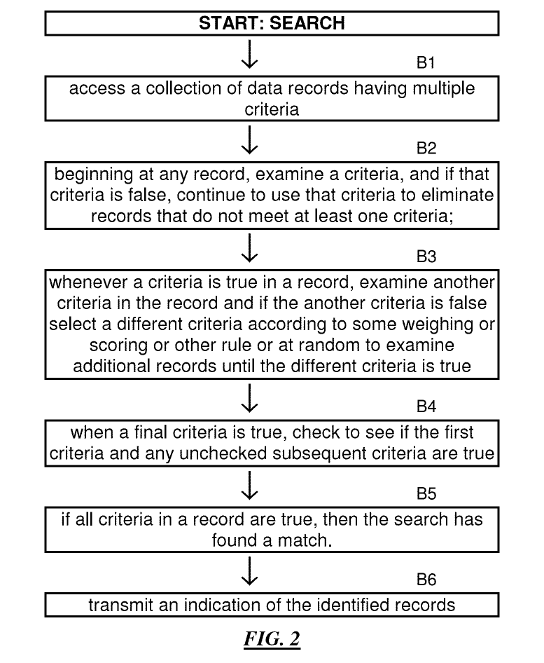

FIG. 1 is a flow chart illustrating a general search method according to specific embodiments of the invention. As shown in the figure, the invention can be embodied in a logical method suitable for implementation by any appropriately configured information handling system, including general purpose computing systems and information handling displays and subsystems. FIG. 2 is a flow chart illustrating an alternate search method according to specific embodiments of the invention.

### Example Embodiments

The present invention has thus far been described in terms of general embodiments. The previous description is believed to be a full and complete description sufficient to allow a practitioner in the art to make and use the invention. It will be understood to those of skill in the art from the teachings provided herein that the described invention or components thereof can be implemented in a wide variety of specific programming environments and logical systems (such as UNIX, Windows, Solaris, Oracle, etc.) using a wide variety of programming languages (such as SQL, Visual Basic, Pascal, C++, Basic, Java, JavaScript, etc.) and wide variety of file formats.

What follows are descriptions of example systems and methods that are involved with or may embody various aspects of the present invention. This following discussion is included, in part, in order to disclose particularly preferred modes presently contemplated for practicing the invention. The following discussion may also include independent innovative embodiments of the invention. It is intended, however, that the previous discussion and the claims not be limited by examples provided herein. It is further intended that the attached claims be read broadly in light of the teachings provided herein. Where specific examples are described in detail, no inference should be drawn to exclude other examples or to exclude examples described or mentioned briefly from the broad descriptions of the invention provided herein. It is therefore intended that the invention not be limited except as provided in the attached claims and equivalents thereof.

### Other Implementation Details

It will be understood from the teachings provided herein, that a method according to the present invention can be variously implemented in computing systems. In one implementation, computer-understandable logic instructions related to the present invention can be included in an application program and/or can be invoked by an application program during initiation and/or execution.

In specific embodiments, such a system can be initiated by a logic routine during program initiation or operating system initiation. It will further be understood from the teachings herein, that logic routines according to the present invention can be included in a logic instruction compiler or logic instruction interpreter and/or include or other files associated with such a programming environment.

### Embodiments in an Information Processing Architecture

As discussed herein, according to specific embodiments, the present invention can be embodied in a method implemented on an information handling system, such as a computer or a variety of other devices that include information handling functionality. Such other devices can include, but are not limited to, personal digital assistants (PDAs), cellular telephones, television set top systems or cable systems interfaces, toys, home appliances with information handling abilities, scientific and diagnostic systems, and machinery or industrial systems with information handling abilities.

Typically, information handling in such systems is performed by binary logic circuits. According to further specific embodiments, the present invention can be embodied in either an information handling system or circuitry or components of an information handling system performing according to the description herein.

According to further specific embodiments, the invention can be embodied as one or more sets of instructions and/or data that are used to program or guide or affect the operation of an information handling system. As is known in the art, these sets of instructions and/or data can be distributed to users stored or recorded on a storage medium, such as a disk, diskette, hard-drive, CD-ROM, tape, ROM, EPROM, ASIC, PLD, etc., and according to specific embodiments, the invention can be embodied as such a medium storing data and/or instructions that when loaded into an appropriately configured information system will cause the system to performing according to the description herein.

As is further known in the art, sets of instructions and/or data can be transmitted to an information handling system over a communication medium (such as the internet, a local area network, a wireless network, a telephone line, a cable-television system, etc.) from a remote data holding location (such as a server) and thereby when loaded into an appropriately configured information system will cause the system to performing according to the description herein.

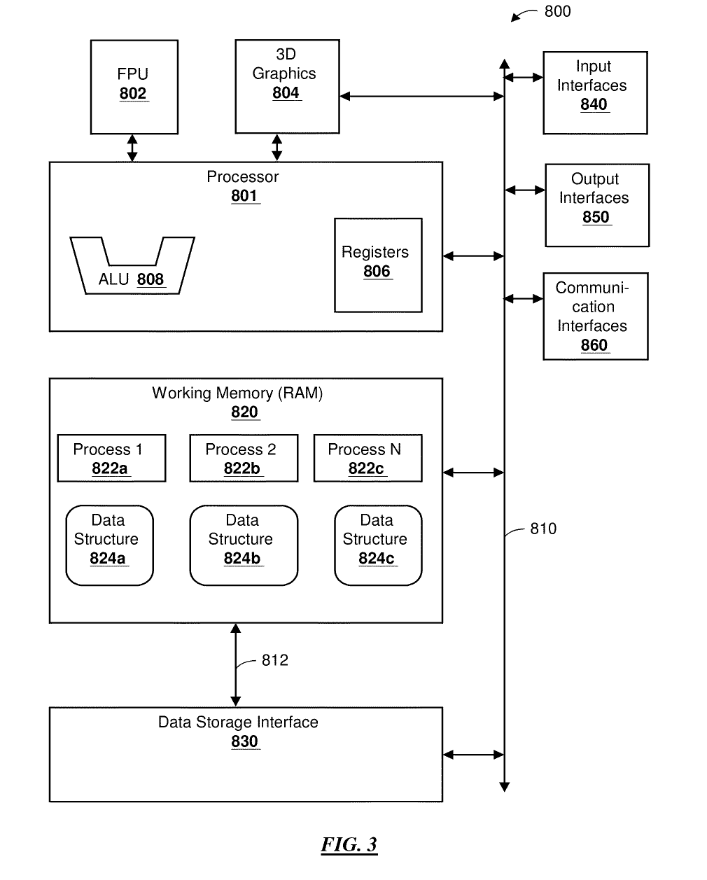

FIG. 3 illustrates an example architecture of an example information handling system relevant to various specific embodiments of the present invention. As will be understood to those of skill in the art and from the teachings provided herein, the general organization of a system 800 as shown in FIG. 3 is representative of various information systems ranging from computer-on-a-chip type circuits in a household appliance or toy to super computer systems and distributed systems. In some information handling systems, the various components shown in FIG. 3 may be separable computer chips or separable circuit areas on a computer chip, whereas in other information handling systems, some or all of the functions shown in FIG. 3 will be performed by shared circuitry or implemented in software. Some systems will not have all of the components shown in FIG. 3, and other systems will have additional core components. FIG. 3 does not represent the only device architecture on which the present invention can be performed and it will be understood that the present invention is applicable to a variety of types of information processing devices.

An information handling device typically includes one or more processors, such as 801. Processor 801 is generally characterized as being able to perform different logic operations on data, where logic operations are selected or specified by one or more instructions. In the example of a personal computer system or workstation, processor 801 can represent any of the number of well-known microprocessors manufactured by companies such as Intel, AMD, Zilog, and Motorola. Processor 801 can also represent a subset of circuitry configured as a processor in an integrated circuit such as an ASIC or PLD.

A processor 801 can at times work in cooperation with other information handling circuits (which may or may not also be processors) that may have special-purpose abilities. These circuits may be external from the processor or internal with the processor. As an example, FIG. 3 shows a floating point unit (FPU) 802 and a 3D graphics module 804. A processor 801 may also have a number of structures to facilitate its operation, such as, for example, a set of internal registers 806 and/or an arithmetic logic unit (ALU) 808. In some processors, these structures are internal to the processor circuitry.

In most information handling systems, various modules communicate with other modules over one or more communication paths or buses. FIG. 3 shows a representative system bus 810 and a separate auxiliary bus 812. The illustrated buses can represent signal channels on an integrated circuit, communication connections on a printed circuit board, connection between two or more printed circuit board or a back-plane, or any other channels used by the modules to exchange data or control signals.

In various information processing systems, separable modules can include such things as working memory 820, one or more storage systems 830, one or more input interfaces 840, one or more output interfaces 850. Some information systems also include a communication interface (such as a network interface or a modem) 860 for communicating with other computer systems, such as over a network. These modules are shown in FIG. 3 as broadly representative of aspects of a computing system.

In typical information processing systems, working memory 820 is some type of random access memory (RAM) that can be quickly accessed by processor 801 and possibly by other processors. In general purpose computers and other computer systems, during operation, such a working memory contains the data and instructions for one or more processes 822, including operating system processes. Each process generally represents an executing program or program thread. Working memory 820 can also include one or more data structures 824, which may be associated with particular processes or may be shared or system-wide. These data structures can include data tables or any other data structures that can be represented in digital memory. Therefore, in many general purpose information processing systems (such as personal computers) working memory 820 will be understood in the art as containing resident parts of an operating system and/or of various application systems and/or data files and/or other logic modules or digital data.

As is familiar to those skilled in the art, an information processing system that is a general purpose type computer system further generally includes an operating system and at least one application program. The operating system is a set of logic instructions that control the computer system's operation and the allocation of resources. The application program is a set of logic instructions (possibly also including data) to perform tasks desired by the user. During operation, both may be resident in a memory system such as 820.

Storage 830 is illustrated to represent other, usually more long-term (also called non-volatile) data storage. In general purpose computers, this typically includes one or more disk-type systems (such as hard-disk drives, floppy drives, CD-ROMs, etc.) and can also include a variety of other storage devices. Storage 830 can be used to supplement working memory 820 through a variety of known paging techniques. Storage 830 can also include remote storage systems available over a network. In hand-held devices especially, storage 830 may consist sole of read-only-memory (ROM) used to store executable components of the system. Depending on particular implementations, 830 can represent either storage systems that are part of computer system 800 or an interface to external storage systems.

Input interfaces 840 can represent circuits, devices, and/logic or instructions that can provide for video, audio, keyboard, pointer, other input to a computer system. Typical input devices include such things as a keyboard or keypad, touch-screen, mouse, microphone, camera, environmental sensors (e.g. a thermostat or a motion detection), etc. Input interfaces 840, along with possibly other modules in the computer system, handle tasks involved in translating external data (such as key strokes) to the appropriate encoded data (typically binary data). These translation tasks can involve multiple steps, performed in various parts of a computer system. Depending on particular implementations, 840 can represent input devices and associated interface logic or only interface logic to particular input devices.

Output interfaces 850 represents circuits, devices, and/or instructions that can provide for video, audio, print or other output from a computer system and can also represent actual output devices. Typical output devices include a display screen, a printer, a speaker, etc. Output can also be in the form of control signals to an external machine such as an engine, manufacturing robot or other computer-controlled device. Output interfaces 850, along with possibly other modules in the computer system, handle tasks involved in translating computer encoded data (typically binary data) to the appropriate form for output. These translation tasks can involve multiple steps, performed in various parts of a computer system. These character codes are then further translated by display driver circuits to produce the electrical signals needed to excite various pixels on a CRT or LCD type display.

Communication interfaces 860 represents circuits, devices, and/or instructions that allow a computer system to communicate with other information handling systems, such as over a telephone dial-up connection or over the world-wide internet.

In accordance with the practices of persons skilled in the art of computer programming, the invention according to specific embodiments is described herein with reference to symbolic representations of operations that are performed by an information processing system. Such operations are sometimes referred to as being computer-executed or processor-executed. It will be appreciated that the operations that are symbolically represented include the manipulation by a CPU or other logic circuitry of electrical signals representing data bits and the maintenance of data bits at memory locations in a memory system, as well as other processing of signals. The memory locations where data bits are maintained are physical locations that have particular electrical, magnetic, optical, or organic properties corresponding to the data bits.

Thus, it will be understood from the teachings herein that the present invention can, according to specific embodiments, be embodied into an information handling system and/or into different separable components of an information handling system.

### Embodiments in a Programmed System

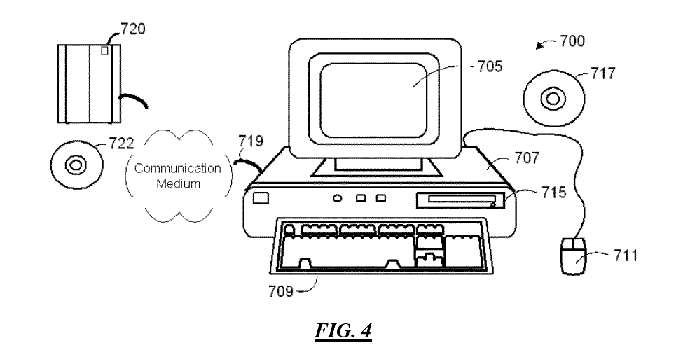

FIG. 4 is a block diagram showing a representative example logic device in which various aspects of the present invention may be embodied. The invention can be implemented in hardware and/or software. In some embodiments of the invention, the invention can be implemented entirely or in part in a client device or a server device, so long as both the client and server are capable of accepting a secondary channel. The invention may be embodied in a fixed media or transmissible program component containing logic instructions and/or data that when loaded into an appropriately configured computing device cause that device to perform according to the invention.

FIG. 4 shows digital device 700 that may be understood as a logical apparatus that can read instructions from media 717 and/or network port 719. Apparatus 700 can thereafter use those instructions to direct a server or client application as is known in the art and that further includes the components of the invention. One type of logical apparatus that may embody the invention is a computer system as illustrated in 700, containing CPU 707, optional input devices 709 and 711, disk drives 715 and optional monitor 705. Fixed media 717 may be used to program such a system and may represent a disk-type optical or magnetic media or a memory. The invention may be embodies in whole or in part as software recorded on this fixed media. Communication port 719 may also be used to program such a system and may represent any type of communication connection.

The invention also may be embodied in whole or in part within the circuitry of an application specific integrated circuit (ASIC) or a programmable logic device (PLD). In such a case, the invention may be embodied in a computer understandable descriptor language which may be used to create an ASIC or PLD that operates as herein described.

### Other Embodiments

The invention has now been explained with reference to specific embodiments. Other embodiments will be apparent to those of skill in the art. In particular, the client's digital computing device has been illustrated as a personal computer. However, the digital computing device is meant to be any device for interacting with a remote application, such as a multimedia messaging server.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed:

1. A method of searching data in a data structure comprising multiple records (e.g., table rows data objects, or any other data structure) a plurality of the records having associated therewith at least two criteria, using an information processing apparatus comprising:
starting with an initial record, determine if a first criteria is true;
if the first criteria is not true, advance to a next record and see if the second criteria is true;
so long as the second criteria is not true, advance to one or more further records and continue to check if the second criteria is true;
if the second criteria is true, check the next criteria, and so long as the next criteria is not true, continue to check the next criteria for following records;
when the next criteria is true, continue checking further criteria as above until either all the records are determined to have at least one false criteria or one or more records are determined to have all criteria true;
when the second to last criteria is true, check a final criteria;
if the final criteria is true, check to see if the first criteria and any unchecked subsequent criteria are true;
if the first criteria and any subsequent criteria are true, then the search has found a match;
if either the final criteria or the first criteria were not true, advance to a subsequent record and continue to see if the final criteria is true.

2. A method of searching data in a data structure comprising multiple records (e.g., table rows data objects, or any other data structure) a plurality of the records having associated therewith a plurality of criteria, using an information processing apparatus, comprising:
beginning at any record, examine a criteria, and if that criteria is false, continue to use that criteria to determine records that do not meet at least one criteria;
whenever a criteria is true in a record, examine another criteria in the record and if the another criteria is false continue to use the another criteria to examine subsequent records until the another criteria is true;
when a final criteria is true, check to see if the first criteria and any unchecked subsequent criteria are true;
if all criteria in a record are true, then the search has found a match.

3. The method of claim 1 further wherein:
data structures and criteria involve one or more of text data, image data, sound data, executable data, or logic data.

4. The method of claim 2 further wherein:
data structures and criteria involve one or more of text data, image data, sound data, executable data, or logic data.

5. The method of claim 1 further wherein:
criteria are ranked or weighted during searching, such that generally whenever a criteria is found to be true, the criteria with the largest number of false matches or the smallest number of true matches is generally picked.

6. The method of claim 2 further wherein:
criteria are ranked or weighted during searching, such that generally whenever a criteria is found to be true, the criteria with the largest number of false matches or the smallest number of true matches is generally picked.

7. The method of claim 1 further wherein:
criteria are ranked or weighted during searching based on how much processing time it takes to search a particular criteria, and criteria that take less processing time are preferred as next criteria when a criteria is found to be true.

8. The method of claim 2 further wherein:
criteria are ranked or weighted during searching based on how much processing time it takes to search a particular criteria, and criteria that take less processing time are preferred as next criteria when a criteria is found to be true.

9. The method of claim 1 further wherein:
criteria that are true are continued to be used until there are a selected number (e.g., 2 or 3) in a row of true instances of that criteria or a selected total number of true instances.

10. The method of claim 2 further wherein:
criteria that are true are continued to be used until there are a selected number (e.g., 2 or 3) in a row of true instances of that criteria or a selected total number of true instances.

11. An apparatus in a computing system for improved searching of stored data structures comprising:
a search logic module for performing criteria searching;
a data access module for accessing stored data; and
an output module for outputting an indication of search results to another module or a user.

12. The apparatus according to claim 11 further comprising a display for presenting results to a user.

13. The apparatus according to claim 11, the search logic module further configured to:
search data in a data structure comprising multiple records (e.g., table rows data objects, or any other data structure), a plurality of the records having associated therewith at least two criteria;
starting with an initial record, determine if a first criteria is true;
if the first criteria is not true, advance to a next record and see if the second criteria is true;
so long as the second criteria is not true, advance to one or more further records and continue to check if the second criteria is true;
if the second criteria is true, check the next criteria, and so long as the next criteria is not true, continue to check the next criteria for following records;
when the next criteria is true, continue checking further criteria as above until either all the records are determined to have at least one false criteria or one or more records are determined to have all criteria true;
when the second to last criteria is true, check a final criteria;
if the final criteria is true, check to see if the first criteria and any unchecked subsequent criteria are true;
if the first criteria and any subsequent criteria are true, determine that a match has been found; and
if either the final criteria or the first criteria were not true, advance to another record and continue to see if the final criteria is true.

14. The apparatus according to claim 11, the search logic module further configured to:
search data in a data structure comprising multiple records (e.g., table rows data objects, or any other data structure), a plurality of the records having associated therewith a plurality of criteria, using an information processing apparatus, comprising:
beginning at any record, examine a criteria, and if that criteria is false, continue to use that criteria to determine records that do not meet at least one criteria;
whenever a criteria is true in a record, examine another criteria in the record and if the another criteria is false continue to use the another criteria to examine subsequent records until the another criteria is true;
when a final criteria is true, check to see if the first criteria and any unchecked subsequent criteria are true;
if all criteria in a record are true, determine the search has found a match.

15. The apparatus according to claim 11 further wherein:
data structures and criteria involve one or more of text data, image data, sound data, executable data, or logic data.

16. The apparatus according to claim 11 further wherein:
criteria are ranked or weighted during searching, such that generally whenever a criteria is found to be true, the criteria with the largest number of false matches or the smallest number of true matches is generally picked.

17. The apparatus according to claim 11 further wherein:
criteria are ranked or weighted during searching based on how much processing time it takes to search a particular criteria, and criteria that take less processing time are preferred as next criteria when a criteria is found to be true.

18. The apparatus according to claim 11 further wherein:
criteria that are true are continued to be used until there are a selected number (e.g., 2 or 3) in a row of true instances of that criteria or a selected total number of true instances.

19. The method of claim 1 further comprising:
providing, in a memory of said information handling system readable by said processor, a logic module able to access one or more data structures; and
establishing a logic routine that executes on said processor.

20. The method of claim 2 further comprising:
providing, in a memory of said information handling system readable by said processor, a logic module able to access one or more data structures; and
establishing a logic routine that executes on said processor.
